(19) United States
(12) Patent Application Publication
(10) Pub. No.: US 2006/0042110 A1
(43) Pub. Date: Mar. 2, 2006

(54) Measuring device

(76) Inventor: Gregory C. Buchner, Los Altos, CA (US)

Correspondence Address: BROWN RAYSMAN MILLSTEIN FELDER & STEINER, LLP, 1880 CENTURY PARK EAST, 12TH FLOOR, LOS ANGELES, CA, 90067, US

(21) Appl. No.: 11/217,797

(22) Filed: Aug. 31, 2005

Related U.S. Application Data
(60) Provisional application No. 60/606,325, filed on Aug. 31, 2004.

(51) Int. Cl. G01B 3/10

(52) U.S. Cl. 33/755

(57) ABSTRACT

The embodiments of the present invention provide an improved tape measure. According to one embodiment, the concave and convex surfaces of the tape measure are etched, scribed, or printed with markings and numbers at fixed intervals. According to another embodiment, the markings and numbers on the convex surface are the same as the markings and numbers on the concave surface. According to another embodiment, the markings and numbers on the convex surface are different from the markings and numbers on the concave surface.

The present application claims the benefit of priority from pending U.S. Provisional Patent Application No. 60/606,325, entitled “Measuring Device”, filed on Aug. 31, 2004, which is herein incorporated by reference in its entirety.

### BACKGROUND OF THE INVENTION

1. Field of the Invention

The present invention is a related to tape measures.

Portions of the disclosure of this patent document contain material that are subject to copyright protection. The copyright owner has no objection to the facsimile reproduction by anyone of the patent document or the patent disclosure as it appears in the Patent and Trademark Office file or records, but otherwise reserves all rights whatsoever.

2. Background Art

A tape measure is used to measure the dimensions of a given item or space. Often the tapes are slightly curved in cross section, with a convex upper surface and concave lower surface. These measuring tapes are usually made of a thin metallic strip painted and coated with a plastic film on both sides. Markings and numbers are scribed, etched, or printed at fixed intervals on the concave surface of the tape measure, while the convex surface of the tape measure has no markings or numbers, and is usually a solid colored surface. For example, the markings may be ⅛^{th} of an inch apart and have numbers to indicate the inches and feet. Since these markings and numbers are only on the concave surface of the tape, the tape measure has to be held in such a way so that the concave surface of the tape is visible to the user. That is, there is a “right side up” orientation to the use of the tape measure. However, there are many situations where it is awkward to use the tape measure in that orientation.

When the measurement of an item requires that the measure tape be held in a way so that the markings and numbers are not visible to the person, for example, to measure the length of a ceiling of a room, the person is forced to flip the tape over in order to read the markings and numbers on the concave surface of the measure tape. In case when the measure of the item is longer than the physical reach of the person making the measurement so that the person cannot hold the housing structure in one hand and the tape measure end in the other, flipping the tape over causes the tape to bend. This forces the tape to physically loose contact with the item being measured and hence an incorrect and inaccurate measurement could be derived.

The bending of the tape measure forces the user to divide the item into smaller sections large enough for the user to physically hold the housing structure in one hand and the tape measure end in the other, making incremental measurements of the item by keeping the concave surface of the tape always visible in order to derive at an accurate measurement. This causes a time delay and in certain cases it may not be possible or practical to divide the item into smaller sections.

### SUMMARY OF THE INVENTION

The embodiments of the present invention provide for an improved tape measure. According to one embodiment, the concave and convex surfaces of the tape measure are etched, scribed, or printed with markings and numbers at fixed intervals. According to another embodiment, the markings and numbers on the convex surface are the same as the markings and numbers on the concave surface. According to another embodiment, the markings and numbers on the convex surface are different from the markings and numbers on the concave surface.

### BRIEF DESCRIPTION OF THE DRAWINGS

These and other features, aspects and advantages of the present invention will become better understood with regard to the following description, appended claims and accompanying drawings where:

FIG. 1 is a view of the concave surface of a tape measure, according to one embodiment of the present invention.

FIG. 2 is a view of the convex surface of a measure, according to one embodiment of the present invention.

### DETAILED DESCRIPTION OF THE INVENTION

The embodiments of the present invention are for an improved tape measure. In the following description, numerous specific details are set forth to provide a more thorough description of embodiments of the invention. It will be apparent, however, to one skilled in the art, that the embodiments of the present invention may be practiced without these specific details. In other instances, well known features have not been described in detail so as not to obscure the invention.

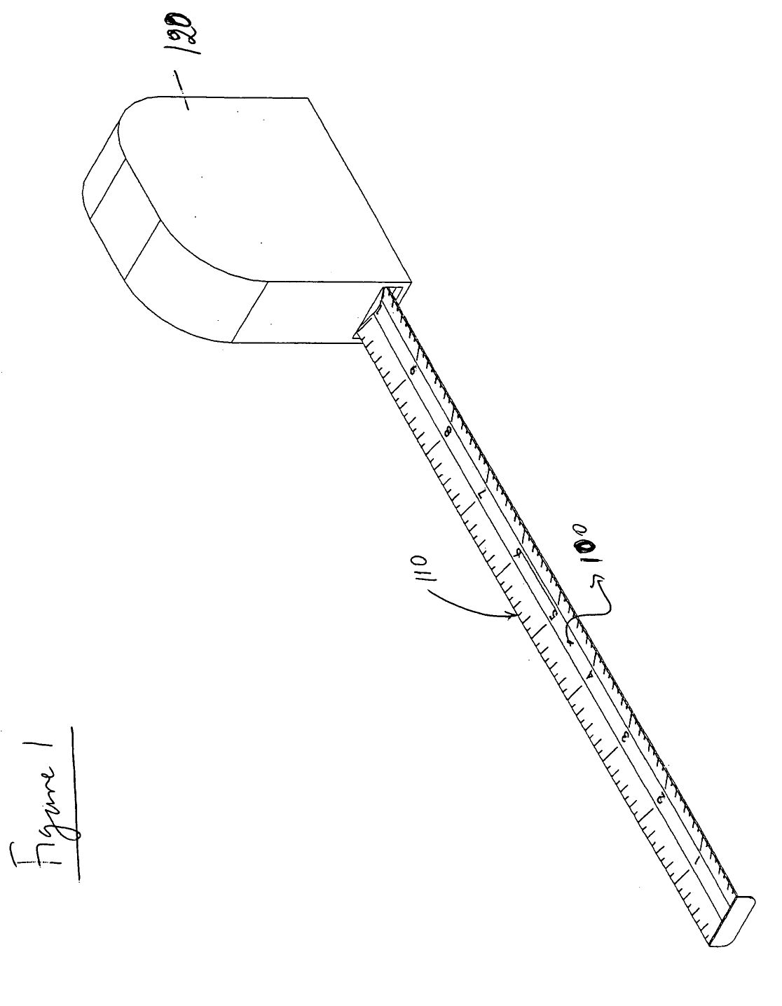

According to one embodiment, the tape measure has markings and numbers on the concave surface of the tape measure. FIG. 1 illustrates markings and numbers on concave surface 100 of tape measure 110. The housing structure 120 receives the tape 110 when released from its extended position.

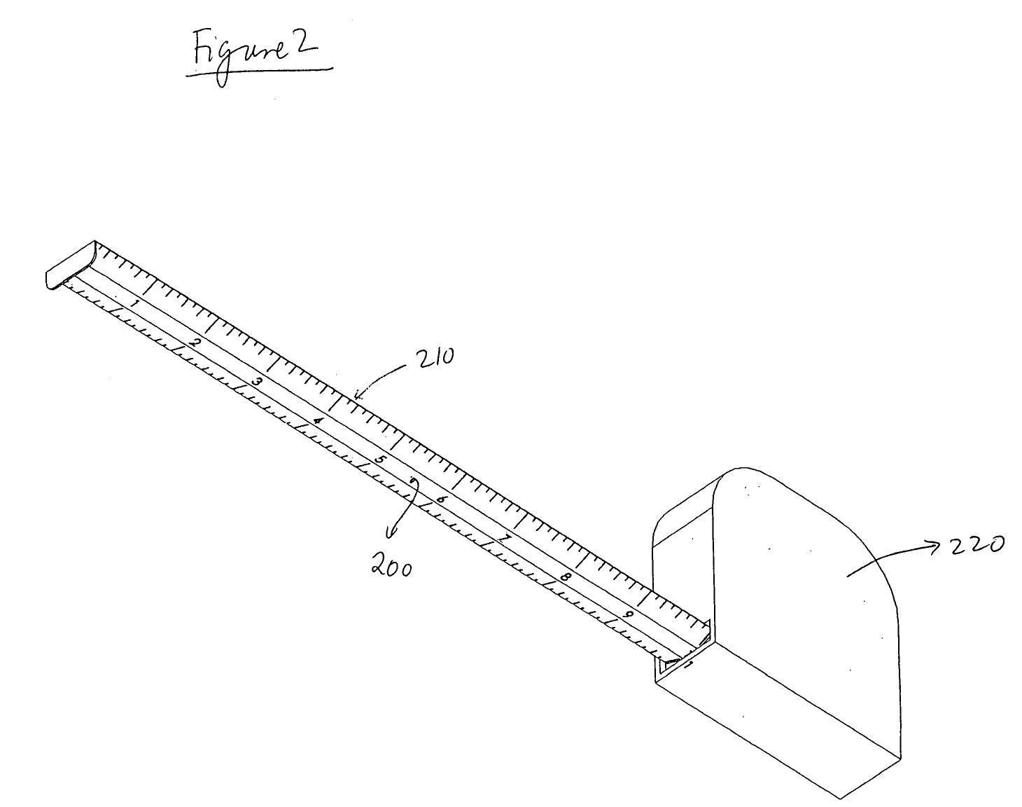

According to another embodiment, the tape measure has markings and numbers on the convex surface of the tape measure. FIG. 2 illustrates markings and numbers on convex surface 200 of tape measure 210. 220 is the housing structure into which tape measure 210 rolls when released from its extended position.

According to another embodiment, the markings on both surfaces of a tape measure indicate the same singular distance. For example, if the convex surface has numbers and markings indicating inches and feet, then the concave surface has the same markings and numbers.

According to another embodiment, the markings and numbers on both surfaces of a tape measure do not indicate the same distance. For example, if the convex surface has numbers and markings indicating inches and feet, the concave surface may have markings and numbers indicating centimeter and meter.

According to another embodiment, the markings and numbers on both surfaces of a tape measure indicate more than one standard of measurement. For example, if the convex surface has numbers and markings indicating a combination of inches and feet, and centimeter and meter, then the concave surface has the same markings and numbers.

In another embodiment, the markings on the top surface increase in one direction while the markings on the bottom surface increase in the other direction. In another embodiment, the direction of increase is the same for both surfaces.

Thus, a design for a shaped tape measure is described in conjunction with one or more specific embodiments. The embodiments of the present invention are defined by the following claims and their full scope of equivalents.

We claim:

1. A shaped tape measure comprising:
a housing containing an extendible tape having top and bottom surfaces;
the first surface having measurement indices marked thereon;
the second surface having measurement indices marked thereon.

2. The tape measure of claim 1 wherein the first surface is marked with measurement indices identical to the measurement indices of the bottom surface.

3. The tape measure of claim 1 wherein the first surface is marked with measurement indices different from the measurement indices of the bottom surface.

4. The tape measure of claim 1 wherein the direction of increase of the measurement indices of the top surface is in the same direction of increase of the measurement indices of the bottom surface.

5. The tape measure of claim 1 wherein the direction of increase of the measurement indices of the top surface is in a different direction of increase of the measurement indices of the bottom surface.
